(19) United States
(12) Patent Application Publication
(10) Pub. No.: US 2025/0181045 A1
(43) Pub. Date: Jun. 5, 2025

(54) REGISTRATION METHOD, INFORMATION PROCESSING APPARATUS, PROGRAM FOR REGISTERING DETAIL OF APPLIANCE CONTROL

(71) Applicant: Panasonic Intellectual Property Corporation of America, Torrance, CA (US)

(72) Inventor: Kenta MURAKAMI, Osaka (JP)

(73) Assignee: Panasonic Intellectual Property Corporation of America, Torrance, CA (US)

(21) Appl. No.: 19/045,382

(22) Filed: Feb. 4, 2025

Related U.S. Application Data
(63) Continuation of application No. PCT/JP2023/029811, filed on Aug. 18, 2023.

(30) Foreign Application Priority Data
Aug. 24, 2022 (JP) 2022-133311

(51) Int. Cl. G05B 15/02; G06F 16/23

(52) U.S. Cl. CPC G05B 15/02; G06F 16/23

(57) ABSTRACT

An information processing apparatus at least includes a processing unit and a registration unit. The processing unit increases, in a history DB showing a history of execution of a block sequence, an execution count of a first block included in the block sequence executed by an appliance and increases, in the history DB, an execution count of a second block similar to the first block. The registration unit registers, in the history DB, a block for which the execution count is a predetermined number of times or more as a repeatedly trustable block.

This application is based upon and claims the benefit of priority from the prior Japanese Patent Application No. 2022-133311, filed on Aug. 24, 2022, the entire contents of which are incorporated herein by reference.

### BACKGROUND

### 1. Field

The present disclosure relates to information processing technology and, particularly, to a registration method, an information processing apparatus, and a program for registering the detail of appliance control.

### 2. Description of the Related Art

Usability of a cooking appliance is improved without requiring a user to touch the cooking appliance for control so long as the user can check or control various data for the cooking appliance. For this purpose, the cooking appliance includes a communication function for communicating with an external terminal, and the user adjusts a parameter of the cooking appliance using the external terminal (see, for example, Patent Literature 1).
[Patent Literature 1] JP2015-72802

In the case the user can freely adjust a parameter of a cooking appliance using an external terminal, the risk of failure in adjustment increases if it is the first time to execute a menu recipe. Further, safety of the cooking appliance may not be guaranteed depending on the combination of parameters. It is therefore preferable for the user to be able to easily set a parameter that is less likely to result in a failure.

### SUMMARY

The present disclosure addresses the issue described above, and a purpose thereof is to provide a technology of easily registering a highly reliable detail of control in an appliance.

A registration method according to an embodiment of the present disclosure includes: receiving information on a block sequence executed by an appliance, the block sequence being comprised of an arrangement of blocks defined in a functional unit executable by the appliance in an order of operation; increasing, in a history database showing a history of execution of the block sequence, an execution count of a first block included in the block sequence executed by the appliance; increasing, in the history database, an execution count of a second block similar to the first block; and registering, in the history database, a block for which the execution count is a predetermined number of times or more as a repeatedly trustable block.

Another embodiment of the present disclosure relates to an information processing apparatus. The apparatus includes: a reception unit that receives information on a block sequence executed by an appliance, the block sequence being comprised of an arrangement of blocks defined in a functional unit executable by the appliance in an order of operation; a processing unit that increases, in a history database showing a history of execution of the block sequence, an execution count of a first block included in the block sequence executed by the appliance and increases, in the history database, an execution count of a second block similar to the first block; and a registration unit that registers, in the history database, a block for which the execution count is a predetermined number of times or more as a repeatedly trustable block.

Optional combinations of the aforementioned constituting elements, and implementations of the disclosure in the form of methods, apparatuses, systems, recording mediums, and computer programs may also be practiced as additional modes of the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1A-1G show a configuration of an appliance control system according to the embodiment;

FIGS. 2A-2E show a configuration of the functional block used in the appliance control system of

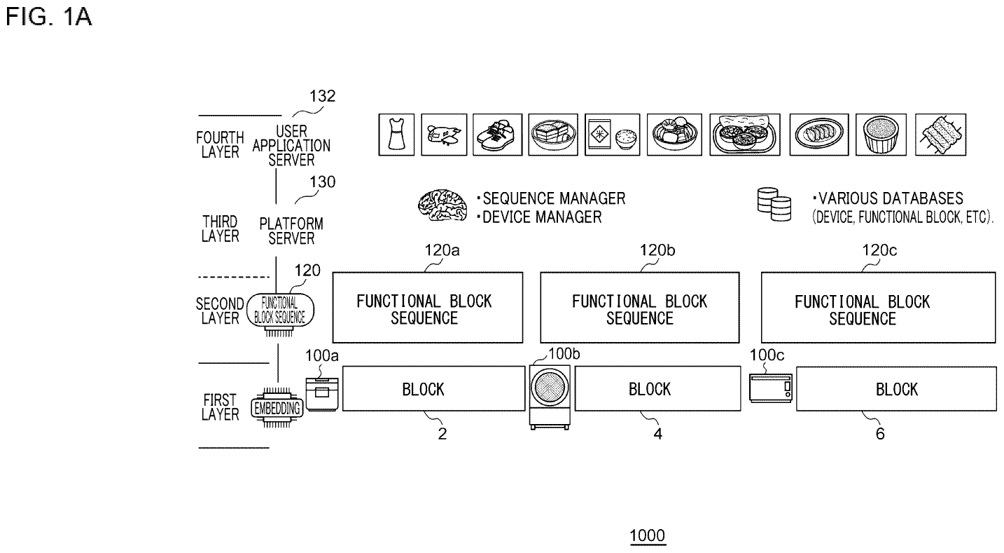

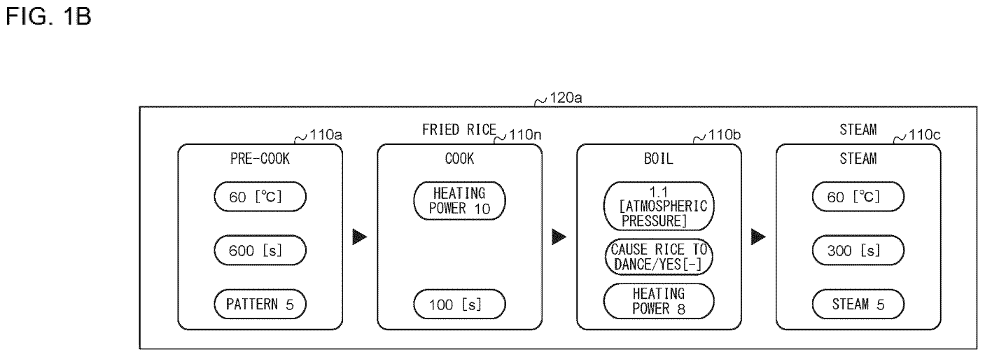

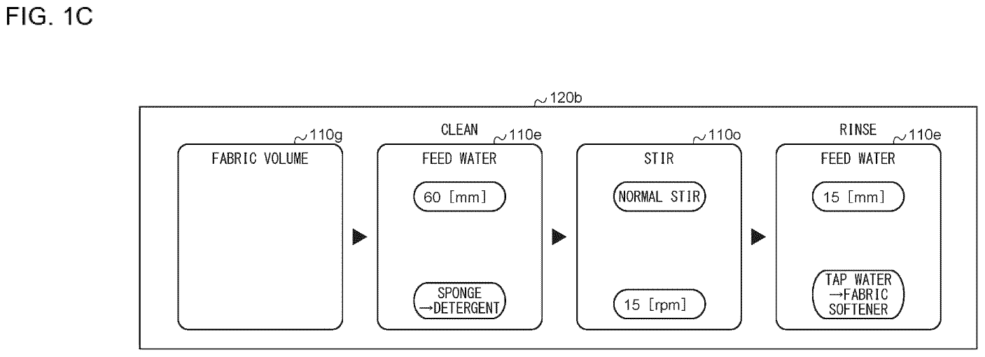

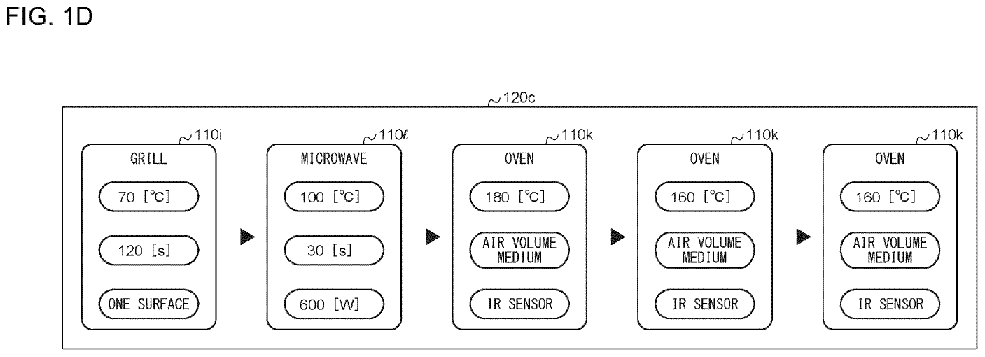

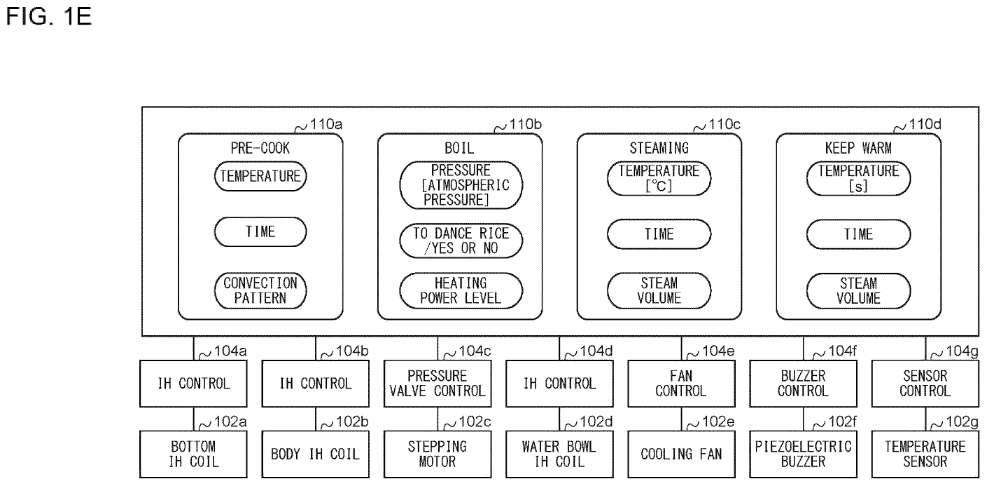

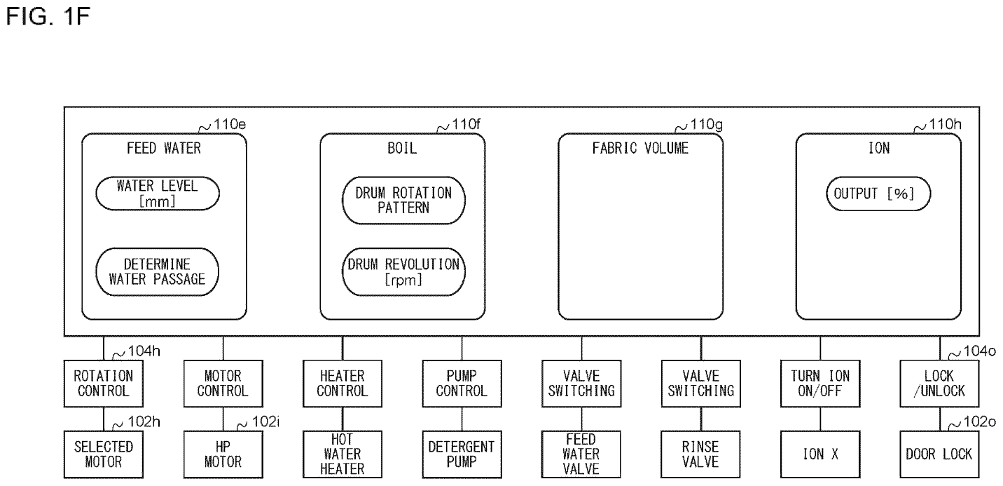

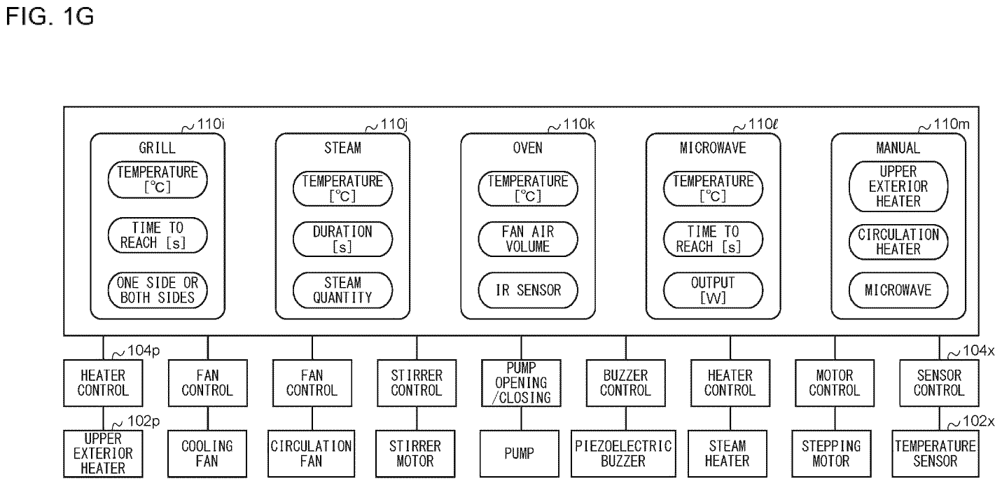

FIGS. 1A-1G;

FIGS. 3A-3H show a configuration of the functional block sequence used in the appliance control system of FIGS. 1A-1G;

FIG. 4 shows an overview of the operation of the appliance of FIGS. 1A-1G;

FIG. 5 shows a configuration of the appliance control system of FIGS. 1A-1G;

FIG. 6 shows a configuration of the appliance of FIG. 5;

FIG. 7 shows a configuration of the sequence creation apparatus of FIG. 5;

FIG. 8 shows a configuration of the information processing apparatus of FIG. 5;

FIG. 9 shows a configuration of the information processing apparatus of FIG. 8;

FIGS. 10A-10B show an overview of a process executed by the processing unit of FIG. 8;

FIGS. 11A-11B show an overview of another process executed by the processing unit of FIG. 8;

FIGS. 12A-12B show an overview of yet another process executed by the processing unit of FIG. 8;

FIG. 13 shows a data structure of a table stored in the storage unit of FIG. 8;

FIGS. 14A-14B show an overview of yet another process executed by the processing unit of FIG. 8;

FIGS. 15A-15B show an overview of yet another process executed by the processing unit of FIG. 8;

FIGS. 16A-16B show an overview of yet another process executed by the processing unit of FIG. 8;

FIG. 17 shows a data structure of the history DB 15 of FIG. 5;

FIG. 18 shows a data structure of the creator DB of FIG. 5;

FIG. 19 is a sequence chart showing a registration procedure executed by the appliance control system of FIG. 5;

FIG. 20 is a flowchart showing a sequence of steps executed by the information processing apparatus of FIG. 8;

FIGS. 21A-21C show an overview of yet another process executed by the processing unit of FIG. 8;

FIG. 22 is a sequence chart showing a modification procedure executed by the appliance control system of FIG. 5;

FIG. 23 is a sequence chart showing an incentive calculation procedure executed by the appliance control system of FIG. 5; and

FIG. 24 shows a data structure of a table stored in the storage unit of FIG. 8.

### DETAILED DESCRIPTION

The invention will now be described by reference to the preferred embodiments. This does not intend to limit the scope of the present invention, but to exemplify the invention.

All of the embodiments described below illustrate preferred embodiments of the present disclosure. Therefore, numerical values, shapes, materials, constituting elements, positions of arrangement and connection forms of constituting elements, and steps and order of steps shown in the following embodiments are examples only and are not presented to limit the present disclosure. Therefore, those of the components in the following embodiments not defined in the independent claims, which present the highest-level concept of the present disclosure, are described as optional constituting elements. Substantially identical features illustrated in the figures are denoted by identical symbols, and a duplicate description is omitted or simplified. Hereinafter, the embodiment is described in the order of: (1) overview of functional block and functional block sequence, (2) configuration of appliance control system, (3) registration of repeatedly trustable blocks, (4) modification of repeatedly trustable block, (5) calculation of incentive, and (6) variation.

### (1) Overview of Functional Block and Functional Block Sequence

In household electrical/mechanical appliances such as a rice cooker, washing machine, and microwave oven (hereinafter referred to as “appliances”), the function/operation of hardware is controlled by software for realizing a specific function. In this embodiment, an appliance control system is introduced as a mechanism to enable creation or updating of software for controlling the appliance.

FIGS. 1A-1G show a configuration of an appliance control system 1000. In the appliance control system 1000, a four-layer model composed of the first to fourth layers is defined. In the first layer, the configuration of the appliance 100 is defined. The appliance 100 is, for example, a rice cooker (appliance 100a), a washing machine (appliance 100b), and a microwave oven (appliance 100c). The appliance 100 is not limited thereto. Each appliance 100 includes a block 2 (FIG. 1E), a block 4 (FIG. 1F), a block 6 (FIG. 1G), a plurality of components 102, a plurality of drivers 104, and a plurality of functional blocks 110.

The component 102 is a hardware element constituting a unit derived from dividing the operation (actuation/sensing) of the appliance 100 and includes an actuator and a sensor that execute the function of the appliance 100. The actuator is an output device and the sensor is an input device. The actuator includes, for example, a bottom IH (Induction Heating) coil (component 102a), a body IH coil (component 102b), a stepping motor (component 102c), a water bowl IH coil (component 102d), a cooling fan (component 102e), and a piezoelectric buzzer (component 102F) in the rice cooker (appliance 100a). The sensor is, for example, a temperature sensor (component 102g) in the rice cooker (appliance 100a). The component 102 included in the rice cooker (appliance 100a) is not limited to these, and the washing machine (appliance 100b) and the microwave oven (appliance 100c) are similarly configured.

The driver 104 is software for directly controlling the component 102. IH control (driver 104) in the rice cooker (appliance 100a) controls the bottom IH coil (component 102a). Further, IH control (driver 104b) controls the body IH coil (component 102b), pressure valve control (driver 104c) controls the stepping motor (component 102c), and IH control (driver 104d) controls the water bowl IH coil (component 102d). Further, fan control (driver 104e) controls the cooling fan (component 102e), buzzer control (driver 104f) controls the piezoelectric buzzer (component 102f), and sensor control (driver 104g) controls the temperature sensor (component 102g). The driver 104 included in the rice cooker (appliance 100a) is not limited to these, and the washing machine (appliance 100b) and the microwave oven (appliance 100c) are similarly configured.

The functional block 110 is a software interface (API: Application Programming Interface) associated with one or more drivers 104 to cause one or more components 102 to operate. The functional block 110 can receive one or more parameters for controlling the operation of the (each) component 102. Details of the functional block 110 will be described later.

In the second layer, a functional block sequence 120 comprised of an arrangement of one or more functional blocks 110 in the order of operation is defined to cause the appliance 100 to execute an intended process. That is, the functional block sequence 120 defines the order of execution of one or more functional blocks 110. The intended process is defined according to the appliance 100, and is, for example, cooking in the case of the rice cooker (appliance 100a) and the microwave oven (appliance 100c) and washing in the case of the washing machine (appliance 100b). The functional block sequence 120a (FIG. 1B) is used in the rice cooker (appliance 100a), the functional block sequence 120b (FIG. 1C) is used in the washing machine (appliance 100b), and the functional block sequence 120c (FIG. 1D) is used in the microwave oven (appliance 100c). The appliance 100 executes the operation in the order of the functional blocks 110 arranged in the functional block sequence 120. Therefore, it is possible to update the function/operation of the appliance 100 by changing the arrangement of the functional blocks 110 or changing a parameter set in the functional block 110. Details of the functional block sequence 120 will be described later.

In the third layer, a platform server 130 that manages various information in the appliance control system 1000 is arranged. The platform server 130 includes a sequence manager, a device manager, and various databases. The sequence manager manages the functional block sequence 120, the device manager manages the registered information on the appliance 100 that can use the functional block sequence 120, and the various databases manage user information on users who can use the functional block sequence 120.

In the fourth layer, a user application server 132 in which each functional block sequence 120 is presented as a user application is arranged. The functional block sequence 120 presented in the user application server 132 is downloaded to the appliance 100. The downloaded functional block sequence 120 is enabled in the appliance 100. When a further functional block sequence 120 is downloaded to the appliance 100, the further functional block sequence 120 is enabled in the appliance 100.

The third and fourth layers of the appliance control system 1000 may be integrated. In that process, the platform server 130 and the user application server 132 are integrally configured. Alternatively, the third and fourth layers in the appliance control system 1000 may be arranged in the same layer. Alternatively, the third and fourth layers in the appliance control system 1000 may be omitted. In that process, the functional block sequence 120 is downloaded to the appliance 100 from the user apparatus (not shown) owned by the user.

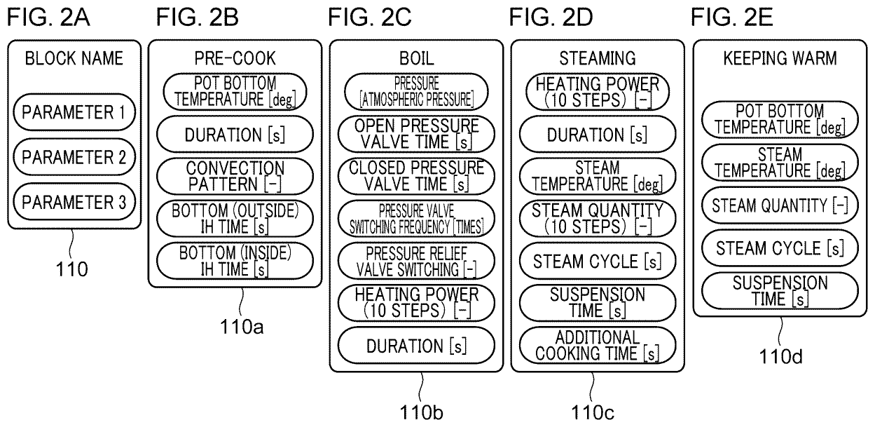

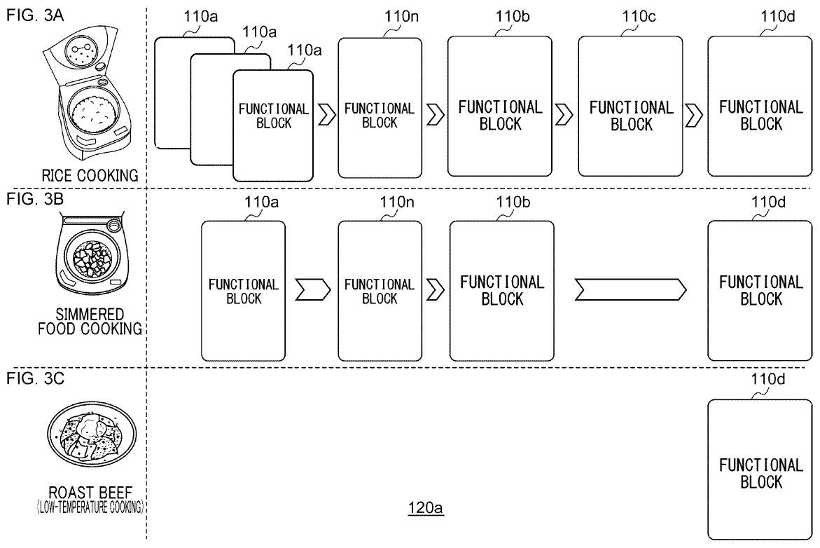

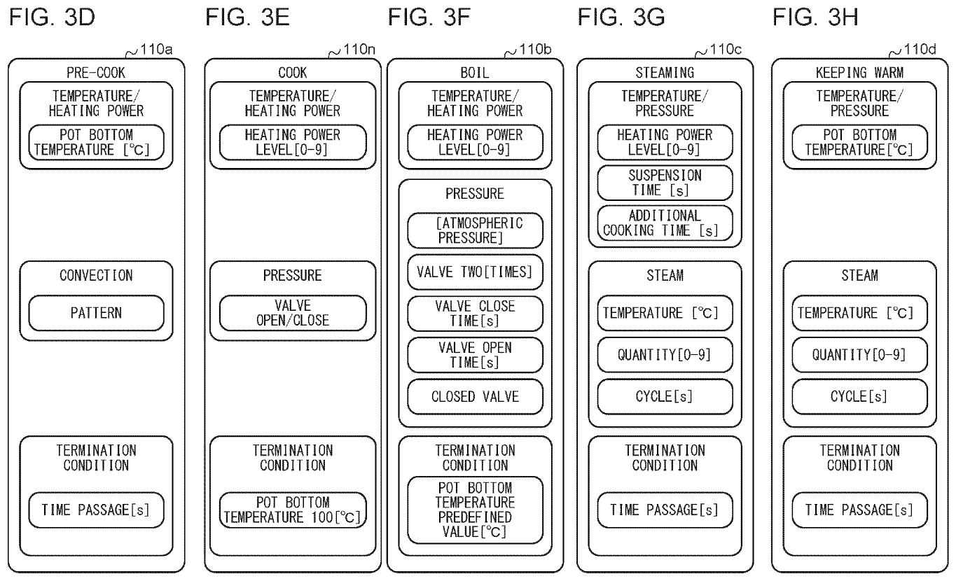

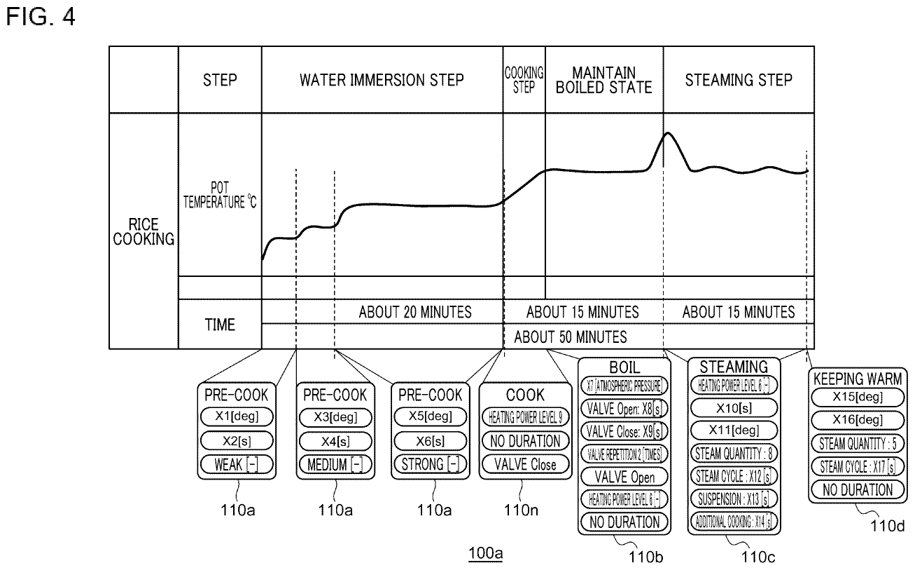

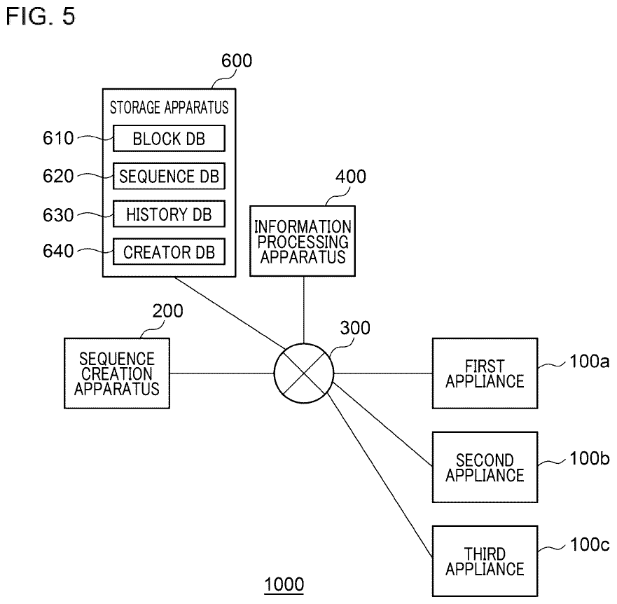

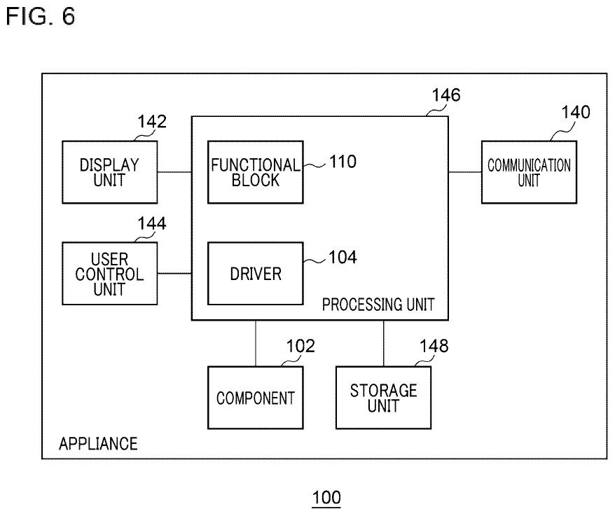

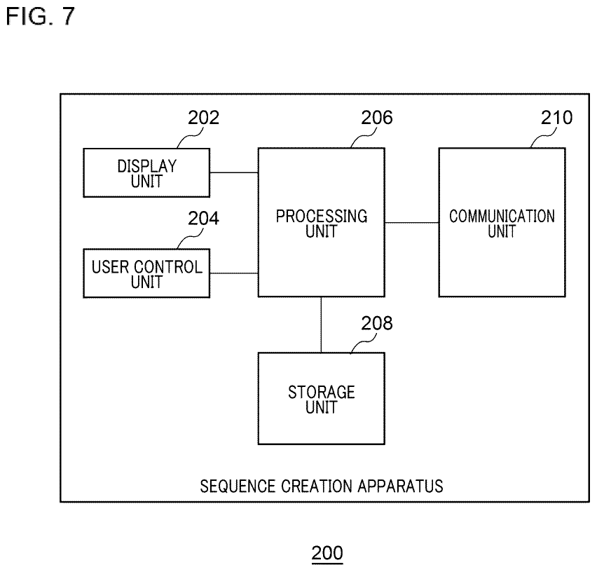

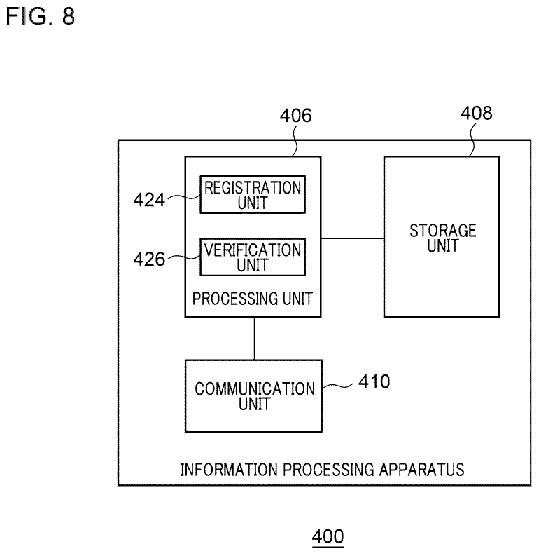

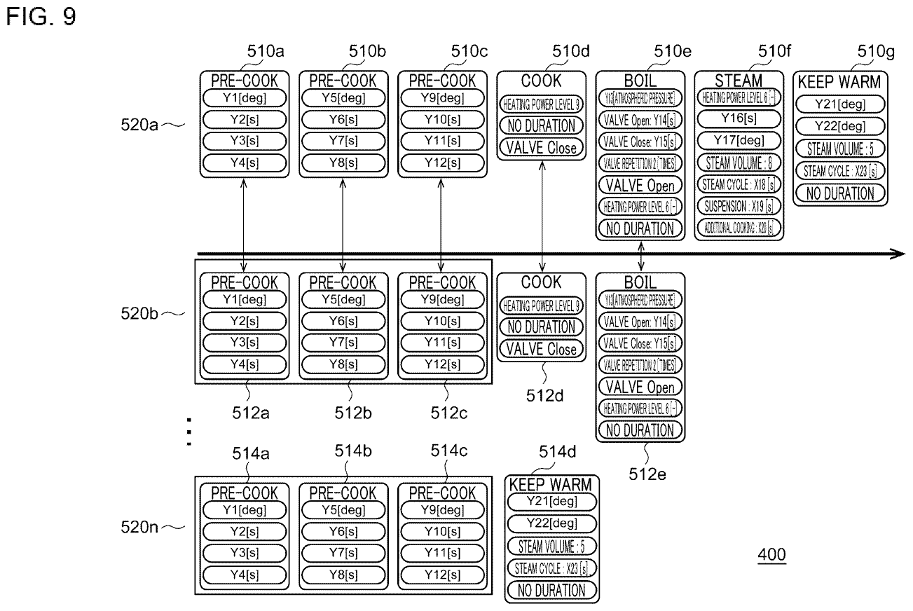

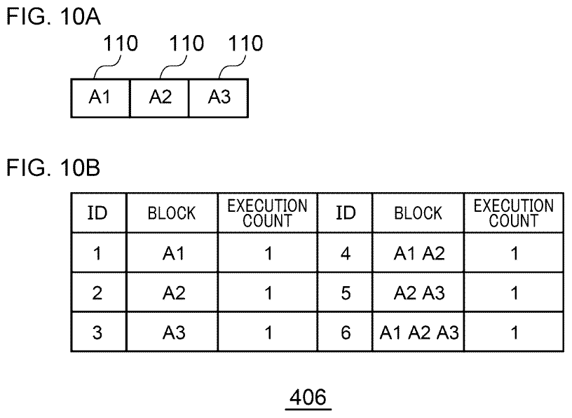

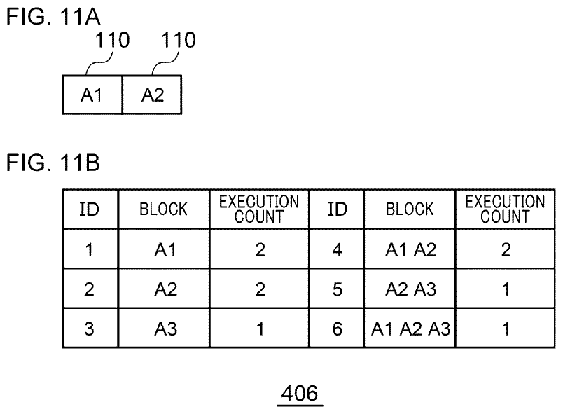

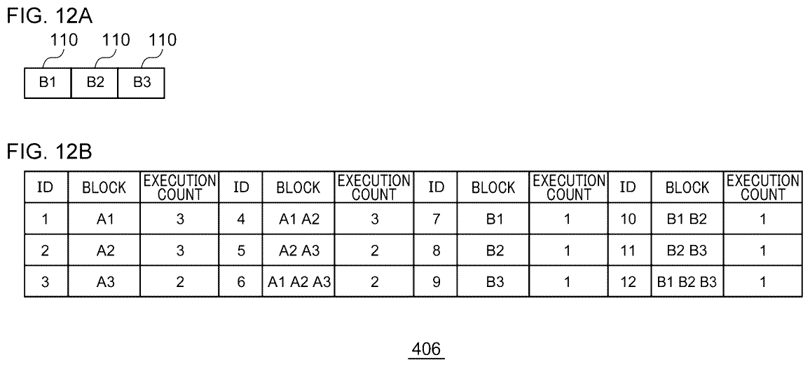

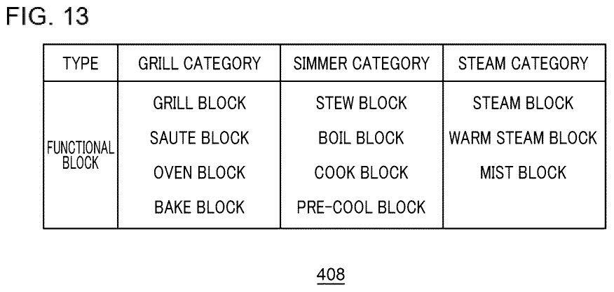

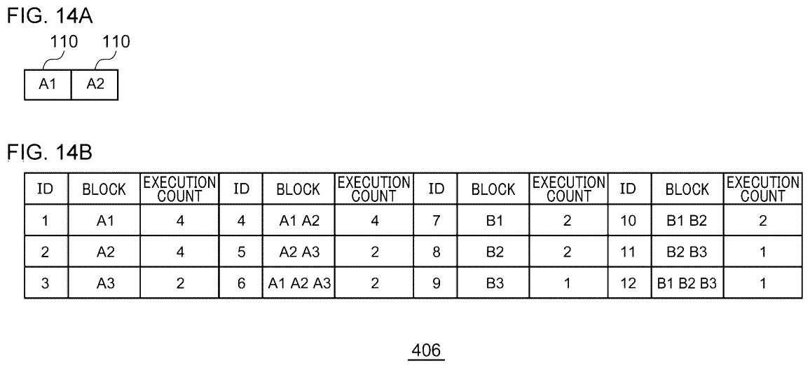

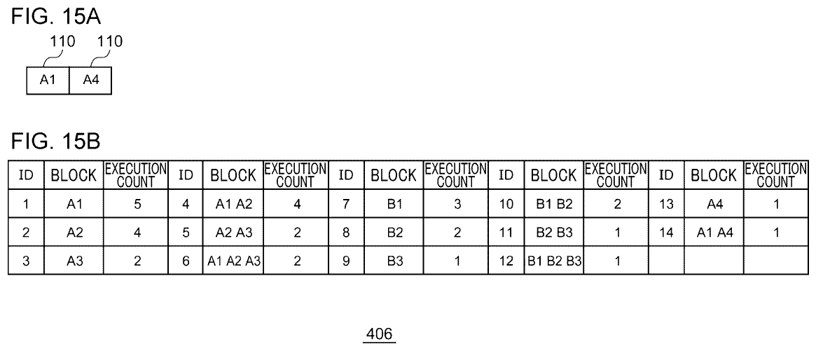

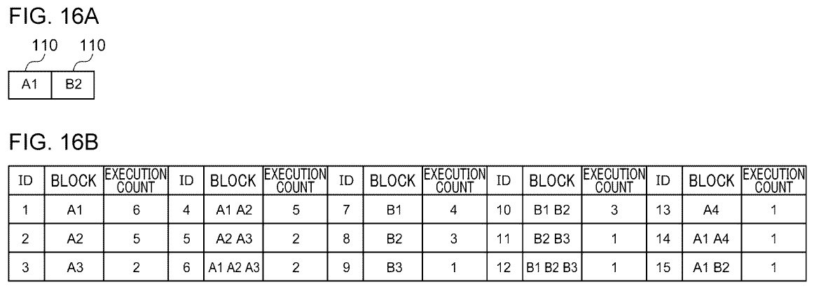

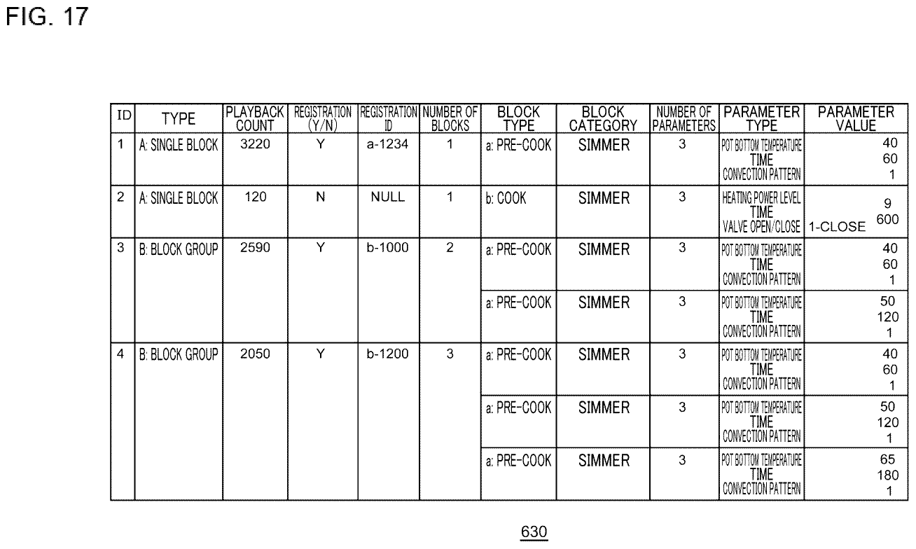

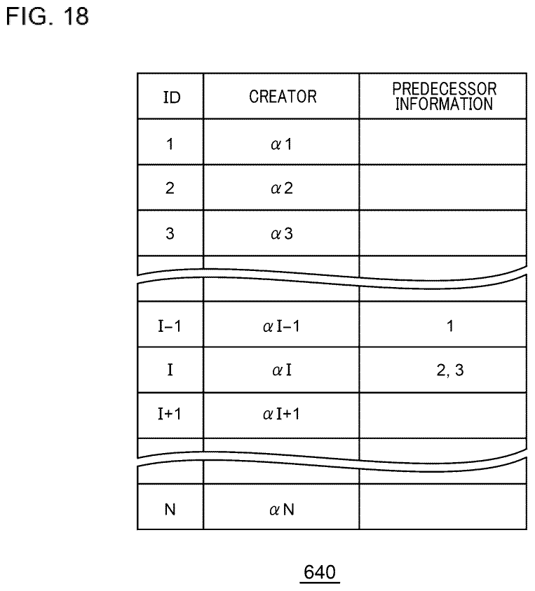

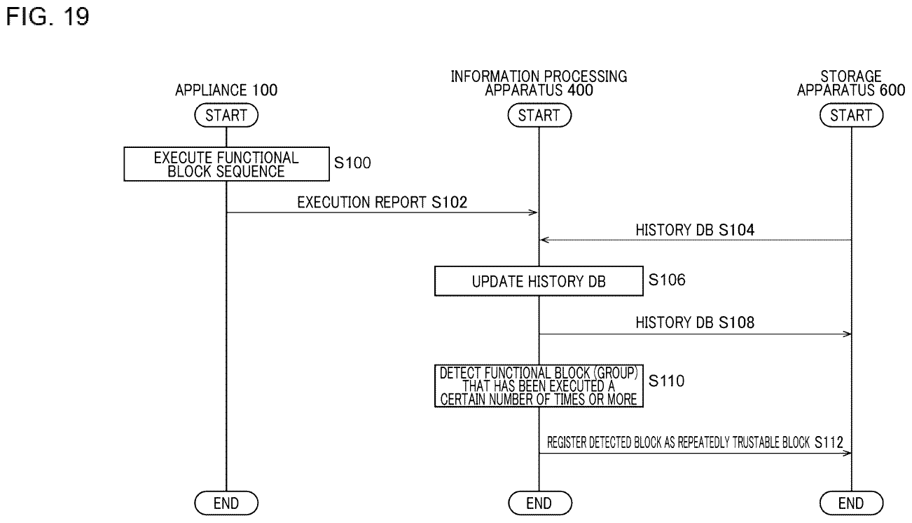

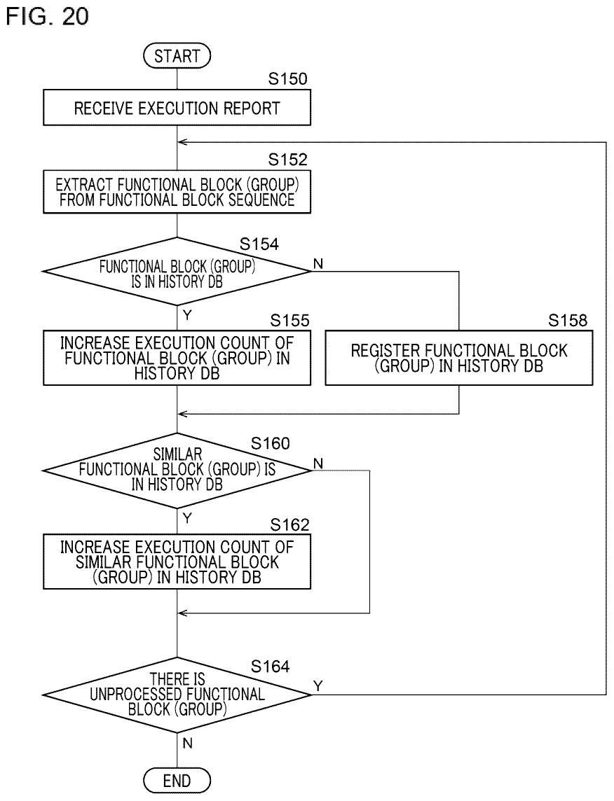

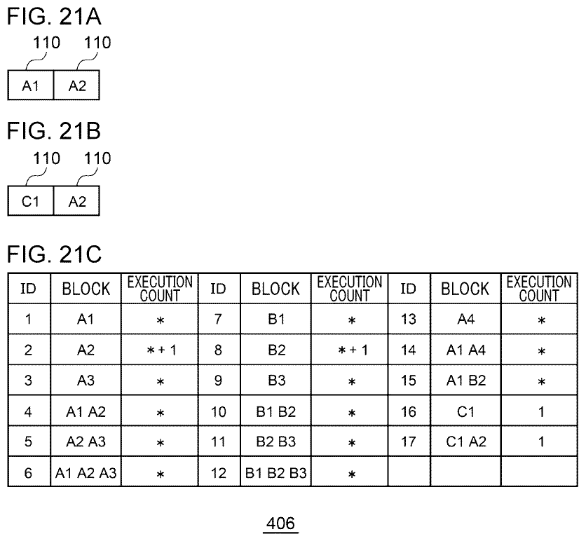

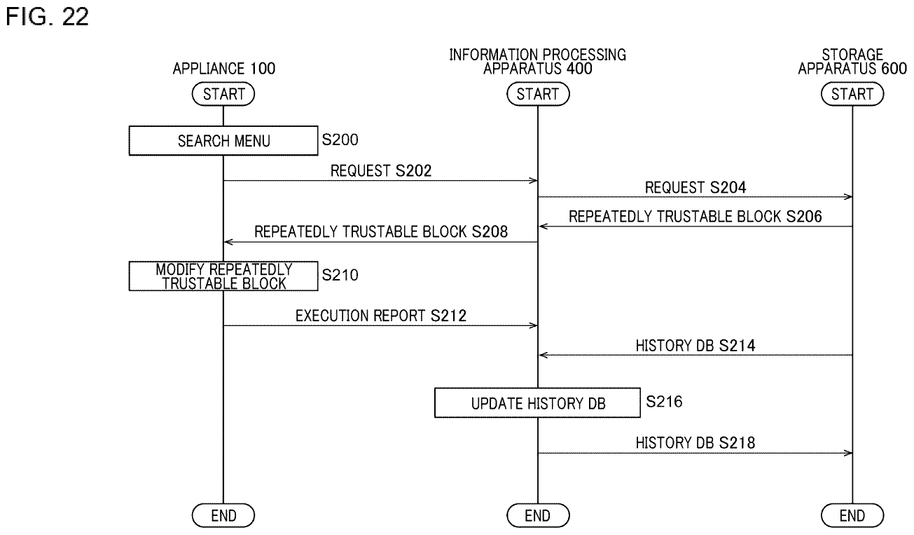

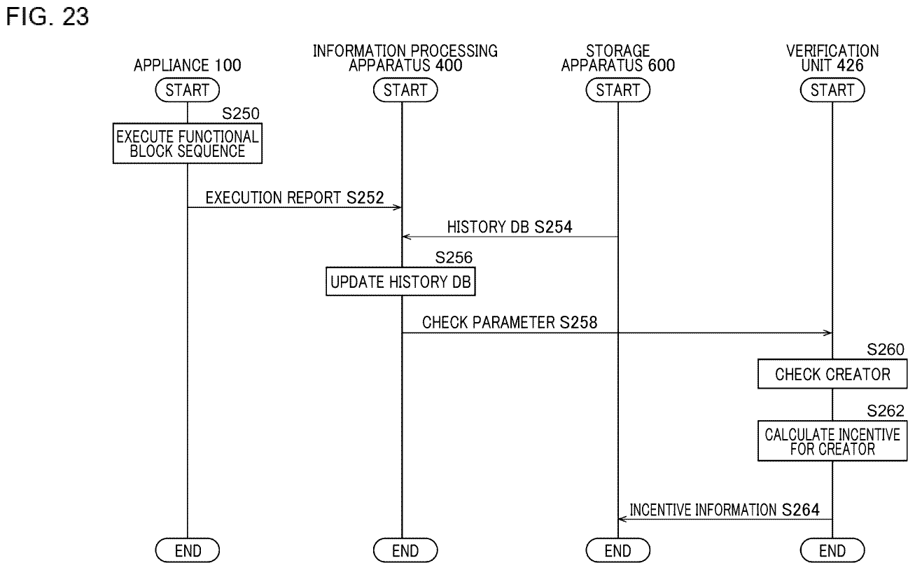

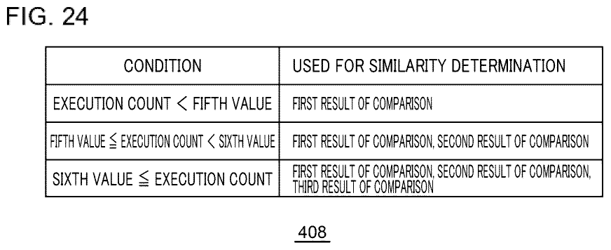

FIGS. 2A-2E show a configuration of the functional block 110 used in the appliance control system 1000. FIG. 2A shows the basic configuration of the functional block 110. The functional block 110 is defined in a functional unit executable by the appliance 100 and has a “block name” determined by the detail of the function. A plurality of parameters determined by the function can be set in the functional block 110. Each parameter set in the functional block 110 is output to the driver 104. When the driver 104 receives the parameter from the functional block 110, the driver 104 controls the operation of the component 102 according to the parameter.

FIG. 2B shows a functional block 110a of “pre-cook” in the rice cooker (appliance 100a) of FIG. 1A. In the functional block 110a of “pre-cook”, parameters including pot bottom temperature, duration, convection pattern, bottom (outside) IH time, and bottom (inside) IH time can be set. FIG. 2C shows a functional block 110b of “boil” in the rice cooker (appliance 100a) of FIG. 1A, FIG. 2D shows a functional block 110c of “steam” in the rice cooker (appliance 100a) of FIG. 1A, and FIG. 2E shows a functional block 110d of “keep warm”. A plurality of parameters can be set in each of the functional block 110b to the functional block 110d as well. The same applies to the functional block 110 in the washing machine (appliance 100b) and the microwave oven (appliance 100c) of FIG. 1A.

FIGS. 3A-3H show a configuration of the functional block sequence 120 used in the appliance control system 1000 and, particularly, the functional block sequence 120a used in the rice cooker (appliance 100a) of FIG. 1A. FIG. 3A shows a sequence for “rice cooking”, FIG. 3B shows a sequence for “simmered food cooking”, and FIG. 3C shows a sequence for “roast beef (low temperature cooking) ”.

In the sequence for “rice cooking” shown in FIG. 3A, three “pre-cook” functional blocks 110a (FIG. 3D), a “cook” functional block 110n (FIG. 3E), the “boil” functional block 110b (FIG. 3F), the “steam” functional block 110c (FIG. 3G), and the “keep warm” functional block 110d (FIG. 3H) are arranged in order. In the three “pre-cook” functional blocks 110a, mutually different parameters are set. By thus arranging the three “pre-cook” functional blocks 110a in which mutually different parameters are set in order, a three-step pre-cooking can be executed.

In the sequence for “simmered food cooking” shown in FIG. 3B, the “pre-cook” functional block 110a, the “cook” functional block 110n, the “boil” functional block 110b, and the “keep warm” functional block 110d are arranged in order. The sequence for “roast beef (low temperature cooking)” shown in FIG. 3C includes the “keep warm” functional block 110d. By thus changing the type, arrangement, and parameters of the functional block 110 used, it is possible to execute processes directed to different purposes of “rice cooking”, “simmered food cooking”, and “roast beef (low-temperature cooking) ”. The same applies to the functional block sequence 120 in the washing machine (appliance 100b) and the microwave oven (appliance 100c) of FIG. 1A.

FIG. 4 shows an overview of the operation of the appliance 100 and, particularly, the rice cooker (appliance 100a) of FIG. 1A. This shows the operation of the appliance 100a according to the sequence for “rice cooking” in FIG. 3A. In the water immersion step, the three “pre-cook” functional blocks 110a with mutually different parameters set are executed in order so that the components 102 corresponding to them operate according to the parameters. As a result, the pot temperature increases in a stepwise manner over time. Following this, the “cook” functional block 110n, the “boil” functional block 110b, the “steam” functional block 110c, and the “keep warm” functional block 110d are executed in order so that the components 102 corresponding to them operate according to the parameters. That is, rice is cooked in the appliance 100a by executing a plurality of functional blocks 110 in order.

### (2) Configuration of Appliance Control System

FIG. 5 shows a configuration of the appliance control system 1000. The appliance control system 1000 includes an appliance 100a to an appliance 100c, a sequence creation apparatus 200, a network 300, an information processing apparatus 400, and a storage apparatus 600. Further, the storage apparatus 600 includes a block DB 610, a sequence DB 620, a history DB 630, and a creator DB 640.

The appliances 100a to 100c are, for example, the rice cooker, etc. shown in FIG. 1A. The appliance 100 executes the process in the first layer of FIG. 1A. Each appliance 100 is connected to the network 300. In the network 300, either wired communication, wireless communication, or a combination of wired communication and wireless communication may be executed. The sequence creation apparatus 200, the information processing apparatus 400, and the storage apparatus 600 are also connected to the network 300.

The storage apparatus 600 is, for example, an HDD (Hard Disk Drive) or an SSD (Solid State Drive) and can store electronic information. The block DB 610 stores the functional block 110 described above. The sequence DB 620 stores the functional block sequence 120 described above. The history DB 630 and the creator DB 640 will be described later.

The sequence creation apparatus 200 is a computer, a smartphone, or a tablet terminal. The sequence creation apparatus 200 acquires a plurality of functional blocks 110 stored in the block DB 610 via the network 300 and creates the functional block sequence 120 using the plurality of functional blocks 110 acquired. Creation of the functional block sequence 120 means arranging the plurality of functional blocks 110 in the order of processing and setting a parameter in each functional block 110.

The information processing apparatus 400 is a server for executing the processes in the second and fourth layers of FIG. 1A and is the user application server 132 of FIG. 1A. The information processing apparatus 400 is, for example, a computer such as a server, a cloud server, etc. provided with a processor, a memory, etc. The information processing apparatus 400 acquires information on the functional block sequence 120 created in the sequence creation apparatus 200 via the network 300 and stores the information on the functional block sequence 120 acquired in the sequence DB 620.

The information processing apparatus 400 acquires the functional block sequence 120 stored in the sequence DB 620 via the network 300 in response to a request for provision of the functional block sequence 120 from the appliance 100 and transmits the functional block sequence 120 acquired to the appliance 100.

After executing the process according to the functional block sequence 120, the appliance 100 transmits information related to the functional block sequence 120 executed (hereinafter also referred to as “execution report”) to the information processing apparatus 400. The information processing apparatus 400 acquires the execution report from the appliance 100 via the network 300 and causes the information on the functional block sequence 120 included in the execution report acquired to be reflected in the history DB 630 showing a history of execution of the functional block sequence 120.

FIG. 6 shows a configuration of the appliance 100. The appliance 100 includes a component 102, a communication unit 140, a display unit 142, a user control unit 144, a processing unit 146, and a storage unit 148. The processing unit 146 includes a functional block 110 and a driver 104. As described above, the appliance 100 is a household electrical/mechanical appliance such as a rice cooker, washing machine, and microwave oven. A plurality of components 102, drivers 104, and functional blocks 110 are provided as shown in FIGS. 1B-1G, but only one is shown here for clarity of the drawing.

The display unit 142 displays the information from the processing unit 146. For example, the display unit 142 can receive information on a list of functional block sequences 120 executable by the appliance 100 from the processing unit 146 and display the list. The user control unit 144 is an interface capable of receiving an input from the user and is, for example, a button. Alternatively, the display unit 142 and the user control unit 144 may be integrated as a touch panel. The user control unit 144 outputs the received input to the processing unit 146. An example of the input is an instruction to select the functional block sequence 120 to be executed.

The processing unit 146 receives an input from the user control unit 144 and, for example, an instruction to select the functional block sequence 120 to be executed. Upon receiving the instruction, the processing unit 146 checks whether the functional block 110 included in the functional block sequence 120 is stored in the storage unit 148. When the functional block 110 included in the functional block sequence 120 is stored in the storage unit 148, the processing unit 146 reads the functional block 110 from the storage unit 148. The processing unit 146 causes the component 102 to operate via the driver 104 in the order of the functional block 110 in the functional block sequence 120.

When the functional block 110 included in the functional block sequence 120 is not stored in the storage unit 148, on the other hand, the processing unit 146 connects to the network 300 via the communication unit 140 and communicates with the information processing apparatus 400 via the network 300. The processing unit 146 causes a request for provision of the functional block sequence 120 to be transmitted the communication unit 140 to the information processing apparatus 400. When the processing unit 146 receives the functional block sequence 120 from the information processing apparatus 400 via the communication unit 140, the processing unit 146 stores the functional block sequence 120 in the storage unit 148. Subsequently, the processing unit 146 reads the functional block 110 from the storage unit 148 and then executes the same operation as before.

After the operation of the component 102 according to the functional block sequence 120 is completed, the processing unit 146 causes the execution report to be transmitted from the communication unit 140 to the information processing apparatus 400.

FIG. 7 shows a configuration of the sequence creation apparatus 200. The sequence creation apparatus 200 includes a display unit 202, a user control unit 204, a processing unit 206, a storage unit 208, and a communication unit 210. As described above, the sequence creation apparatus 200 is a computer, a smartphone, or a tablet terminal. The display unit 202 displays information received from the processing unit 206. The user control unit 204 is an interface capable of receiving an input from the user and is, for example, a button. Alternatively, the display unit 202 and the user control unit 204 may be integrated as a touch panel. The user control unit 204 outputs the received input to the processing unit 206.

The processing unit 206 receives an input from the user control unit 204. Further, the processing unit 206 causes the storage unit 208 to store information or reads information from the storage unit 208. Further, the processing unit 206 connects to the network 300 via the communication unit 210 and communicates with the information processing apparatus 400 via the network 300. The processing unit 206 creates the functional block sequence 120 based on an input from the user while communicating with the information processing apparatus 400.

FIG. 8 shows a configuration of the information processing apparatus 400. The information processing apparatus 400 includes a processing unit 406, a storage unit 408, and a communication unit 410. The processing unit 406 includes a registration unit 424 and a verification unit 426. The processing unit 406 executes the process in the information processing apparatus 400. The storage unit 408 stores information used in the processing unit 406. The communication unit 410 is connected to the network 300 and communicates with the sequence creation apparatus 200 or the appliance 100 or the storage apparatus 600 via the network 300.

For example, the communication unit 410 receives information on the functional block sequence 120 created in the sequence creation apparatus 200 from the sequence creation apparatus 200. The processing unit 406 causes the information on the functional block sequence 120 acquired to be transmitted from the communication unit 410 to the storage apparatus 600. Thereby, the sequence DB 620 stores the functional block sequence 120 created in the sequence creation apparatus 200.

Further, the communication unit 410 receives a request for provision of the functional block sequence 120 from the appliance 100. The processing unit 406 accesses the storage apparatus 600 via the communication unit 140 and acquires the functional block sequence 120 stored in the sequence DB 620 from the storage apparatus 600. The communication unit 140 transmits the functional block sequence 120 acquired to the appliance 100.

Further, the communication unit 410 receives the execution report from the appliance 100. The processing unit 406 reflects the execution report in the history DB 630 of the functional block sequence 120 included in the execution report.

### (3) Registration of Repeatedly Trustable Blocks

As described above, it is possible to create the functional block sequence 120 freely by arranging a plurality of functional blocks 110. However, the user does not understand the operation of each component 102 in detail. It is therefore difficult to understand which functional block 110 should be combined to realize an operation suited to the user's needs. Further, the safety of the appliance 100 may be reduced depending on the combination of the functional block 110. As a result, motivation to create the functional block sequence 120 is reduced.

For such a user, it is desirable that the functional block 110 having some reliability be made available. This is addressed in the embodiment by registering the functional block 110 or a combination of the functional blocks 110 that is frequently used as a repeatedly trustable block in the functional block sequence 120. The user can create the functional block sequence 120 easily by using the repeatedly trustable block.

FIG. 9 shows a configuration of the information processing apparatus 400. For convenience of description, the functional block sequence 120 described so far (for example, the functional block sequence 120a) is referred to as a functional block sequence 520a, a functional block sequence 520b, and a functional block sequence 520n. The functional block sequence 520a to the functional block sequence 520n are functional block sequences 120 that have been executed in various appliances 100a so far.

In the functional block sequence 520a, a functional block 510a (pre-cook), a functional block 510b (pre-cook), a functional block 510c (pre-cook), a functional block 510d (cook), a functional block 510e (boil), a functional block 510f (steam), and a functional block 510g (keep warm) are arranged in order. In the functional block sequence 520b, a functional block 512a (pre-cook), a functional block 512b (pre-cook), a functional block 512c (pre-cook), a functional block 512d (cook), and a functional block 512e (boil) are arranged in order. In the functional block sequence 520n, a functional block 514a (pre-cook), a functional block 514b (pre-cook), a functional block 514c (pre-cook), and a functional block 514d (keep warm) are arranged in order. The functional block 510, the functional block 512, and the functional block 514 correspond to the functional block 110 described so far.

Comparing the functional block sequence 520a through the functional block sequence 520n, the functional block 510a, the functional block 512a, and the functional block 514a included therein have the same detail. Therefore, the frequency of use of the functional block 510a, etc. is high. Further, the functional block 510b, the functional block 512b, and the functional block 514b also have the same detail, and the functional block 510b, etc. is used frequently. Further, the combination of functional blocks 510a to 510c in the functional block sequence 520a has the same detail as the combination of the functional blocks 512a to 512c in the functional block sequence 520b, and the combination of the functional blocks 514a to 514c in the functional block sequence 520n. Therefore, the frequency of use of the combination of the functional block 510a to the functional block 510c is also high.

The functional block 110 or the combination of the functional blocks 110 that is frequently used like this is used by many users. That is, it can be said that the functional block 110 or the combination of the functional blocks 110 like this can realize an operation suited to the needs of many users and also can suppress a decrease in the safety of the appliance 100. The information processing apparatus 400 registers the functional block 110 or the combination of the functional blocks 110 like this as a repeatedly trustable block.

Hereinafter, the process in the information processing apparatus 400 for registering the repeatedly trustable block will be described. FIGS. 10A-10B show an overview of a process executed by the processing unit 406. FIG. 10A shows information on the functional block sequence 120 included in the execution report newly acquired by the processing unit 406 (FIG. 8) of the information processing apparatus 400. In this example, the functional block 110 “A1” (hereinafter simply referred to as “A1”), the functional block 110 “A2” (hereinafter simply referred to as “A2”), and the functional block 110 “A3” (hereinafter simply referred to as “A3”) are arranged in order. “A1”, “A2”, and “A3” are the functional blocks 110 of arbitrary functions.

The processing unit 406 causes the information on the functional block sequence 120 to be reflected in the history DB 630. FIG. 10B shows a data structure of the history DB 630. For clarity of the description, it is assumed that no information has been stored in the history DB 630 so far. The processing unit 406 assigns IDs “1”, “2”, and “3” to “A1”, “A2”, and “A3”, respectively, and records an execution count “1” respectively. Further, “A1”, “A2”, and “A3” comprise a combination of “A1” and “A2”, a combination of “A2” and “A3”, and a combination of “A1”, “A2” and “A3”. The processing unit 406 assigns an ID “4” to the combination of “A1” and “A2” and records an execution count “1”. Further, the processing unit 406 assigns an ID “5” to the combination of “A2” and “A3” and records an execution count “1”. Further, the processing unit 406 assigns an ID “6” to the combination of “A1”, “A2”, and “A3” and records an execution count “1”.

When an ID is assigned to the functional block 110 or a combination of the functional blocks 110, the processing unit 406 extracts, from the information on the functional block sequence 120 acquired, information related to the source of transmission of the information. The processing unit 406 causes the information on the source of transmission to be stored in the creator DB 640 as the creator of the functional block 110 or the combination of the functional blocks 110.

FIGS. 11A-11B show an overview of another process (process following FIGS. 10A-10B) executed by the processing unit 406. FIG. 11A shows information on the functional block sequence 120 included in the execution report newly acquired by the processing unit 406 (FIG. 8) of the information processing apparatus 400. In this example, “A1” and “A2” are arranged in order.

The processing unit 406 causes the information on the functional block sequence 120 to be reflected in the history DB 630. FIG. 11B shows a data structure of the history DB 630. The processing unit 406 checks whether each of “A1” and “A2” included in the functional block sequence 120 executed is included in the history DB 630. Since the history DB 630 includes each of “A1” and “A2”, the processing unit 406 increases the execution count of each of “A1” and “A2” in the history DB 630 from “1” to “2”. Further, the processing unit 406 checks whether the combination of “A1” and “A2” included in the functional block sequence 120 executed is included in the history DB 630. Since the history DB 630 includes the combination of “A1” and “A2”, the processing unit 406 increases the execution count of the combination of “A1” and “A2” in the history DB 630 from “1” to “2”.

FIGS. 12A-12B show an overview of yet another process (process following FIGS. 11A-11B) executed by the processing unit 406. FIG. 12A shows information on the functional block sequence 120 included in the execution report newly acquired by the processing unit 406 (FIG. 8) of the information processing apparatus 400. In this example, the functional block 110 “B1” (hereinafter simply referred to as “B1”), the functional block 110 “B2” (hereinafter simply referred to as “B2”), and the functional block 110 “B3” (hereinafter simply referred to as “B3”) are arranged in order. “B1”, “B2”, and “B3” are the functional blocks 110 of arbitrary functions.

The processing unit 406 causes the information on the functional block sequence 120 to be reflected in the history DB 630. FIG. 12B shows a data structure of the history DB 630. The processing unit 406 checks whether each of “B1”, “B2”, and “B3” included in the functional block sequence 120 executed is included in the history DB 630. Since the history DB 630 does not include each of “B1”, “B2”, and “B3”, the processing unit 406 assigns IDs “7”, “8”, and “9” to “B1”, “B2”, and “B3”, respectively, and records an execution count “1” respectively. Further, “B1”, “B2”, and “B3” comprise a combination of “B1” and “B2”, a combination of “B2” and “B3”, and a combination of “B1”, “B2” and “B3”. These combinations are not included in the history DB 630. Therefore, the processing unit 406 assigns an ID “10” to the combination of “B1” and “B2” and records an execution count “1”. Further, the processing unit 406 assigns an ID “11” to the combination of “B2” and “B3” and records an execution count “1”. Further, the processing unit 406 assigns an ID “12” to the combination of “B1”, “B2”, and “B3” and records an execution count “1”.

Subsequently, the processing unit 406 checks whether the functional block 110 similar to “B1”, “B2”, and “B3” is included in the history DB 630. In this example, a process for checking whether the functional block 110 similar to “B1” is included in the history DB 630 will first be described. The processing unit 406 derives a similarity between “B1” and each functional block 110 in the history DB 630. To derive the similarity, the processing unit 406 uses (i) the type of the functional block 110, (ii) the number of parameters included in the functional block 110, and (iii) the value of the parameter included in the functional block 110.

### (i) Type of Functional Block 110

A plurality of types of functional blocks 110 are defined according to the detail of the function, and the functional block is adapted to receive one or more parameters. A category that aggregates similar functional blocks 110 is defined in advance. FIG. 13 shows a data structure of a table stored in the storage unit 408 and, particularly, a table related to categories. The functional blocks 110 of “grill”, “saute”, “oven”, and “bake” are grouped into a “grill category”. Further, the functional blocks 110 of “stew”, “boil”, “cook”, and “pre-cook” are grouped into a “simmer category”. Furthermore, the functional blocks 110 of “steam”, “warm steam”, and “mist” are grouped into “a steam category”. Reference is made back to FIG. 9.

When “B1” and each functional block 110 in the history DB 630 are the same, the processing unit 406 determines that the first comparison result is “2”. Further, when “B1” and each functional block 110 in the history DB 630 are not the same but are included in the same category, the processing unit 406 determines that the first comparison result is “1”. Further, when “B1” and each functional block 110 in the history DB 630 are not included in the same category, the processing unit 406 determines that the first comparison result is “0”.

### (ii) Number of Parameters Included in the Functional Block 110

The processing unit 406 compares the number of parameters included in “B1” with the number of parameters included in each functional block 110 in the history DB 630. When the difference in the number of parameters is smaller than the first value, the processing unit 406 determines that the second comparison result is “2”. Further, when the difference in the number of parameters is equal to or greater than the first value and is smaller than the second value, the processing unit 406 determines that the second comparison result is “1”. Further, when the difference in the number of parameters is equal to or greater than the second value, the processing unit 406 determines that the second comparison result is “0”. It should be noted here that the relationship the first value<the second value holds. For example, the first value is “1”, and the second value is “3”. When the first value is “1”, the second comparison result “2” represents a match in the number of parameters.

(iii) Value of the Parameter Included in the Functional Block 110

The processing unit 406 compares the parameter included in “B1” with the parameter included in each functional block 110 in the history DB 630 to determine whether they are the same parameter. When the processing unit 406 determines that the parameters are the same, the processing unit 406 calculates a difference between the values of the parameters. The difference between the values of the parameter may be normalized. When the difference is smaller than the third value, the processing unit 406 determines that the third comparison result is “2”. Further, when the difference is equal to or greater than the third value and smaller than the fourth value, the processing unit 406 determines that the third comparison result is “1”. Further, when the difference is equal to or greater than the fourth value, the processing unit 406 determines that the third comparison result is “0”. It should be noted here that the relationship the third value<the fourth value holds. When “B1” and the functional block 110 in the history DB 630 include a plurality of parameters, the processing unit 406 derives the third comparison result for each parameter and determines the smallest value among them to be the ultimate third comparison result.

### (iv) Type of Parameter Included in the Functional Block 110

Like the category (FIG. 13) defined for the functional block 110, a category that aggregates similar parameters is defined in advance for the parameters included in the functional block 110. When the parameter of the functional block 110 included in the functional block sequence 120 executed and the parameter of the functional block 110 in the history DB 630 are the same, the processing unit 406 determines that the fourth comparison result is “2”. Further, when the parameter of the functional block 110 included in the functional block sequence 120 executed and the parameter of the functional block 110 in the history DB 630 are not the same but are included in the same category, the processing unit 406 determines that the fourth comparison result is “1”. Further, when the parameter of the functional block 110 included in the functional block sequence 120 executed and the parameter of the functional block 110 in the history DB 630 are not included in the same category, the processing unit 406 determines that the fourth comparison result is “0”.

The processing unit 406 determines whether “B1” is similar to the functional block 110 in the history DB 630 using the similarity including the first to fourth comparison results. For example, when at least one of the first to fourth comparison results is “0”, the processing unit 406 determines that “B1” and the functional block 110 in the history DB 630 are not similar. Otherwise, on the other hand, the processing unit 406 determines that “B1” is similar to the functional block 110 in the history DB 630. As a result, the processing unit 406 identifies the functional block 110 as the functional block 110 similar to “B1”. It should be noted that when all of the first to fourth comparison results are “2”, “B1” and the functional block 110 in the history DB 630 are the same so that “B1” included in the functional block sequence 120 executed is processed as being included in the history DB 630.

Such a process is also applied to “B2” and “B3”. Referring to the example of FIG. 12B, it is assumed that “A1” and “B1” are similar, “A2” and “B2” are similar, and “A3” and “B3” are similar. Since “B1” and “A1” are similar, the processing unit 406 increases the execution count of “A1” in the history DB 630 from “2” to “3”. Further, since “B2” and “A2” are similar, the processing unit 406 increases the execution count of “A2” in the history DB 630 from “2” to “3”. Further, since “B3” and “A3” are similar, the processing unit 406 increases the execution count of “A3” in the history DB 630 from “1” to “2”.

Further, comparing the combination of “A1” and “A2” included in the history DB 630 with the combination of “B1” and “B2” included in the functional block sequence 120 executed, both two functional blocks are similar. In such a case, the processing unit 406 determines that the combination of “A1” and “A2” is similar to the combination of “B1” and “B2”. That is, given the combination of two or more functional blocks 110 included in the functional block sequence 120 executed and the combination of two or more functional blocks 110 included in the history DB 630, the processing unit 406 determines that these combinations are similar when all functional blocks 110 are similar or when there is a mixture of identical functional blocks 110 and similar functional blocks 110. Thus, the processing unit 406 increases the execution count of the combination of “A1” and “A2” in the history DB 630 from “2” to “3”. The same applies to the combination of “A2” and “A3” and the combination of “A1”, “A2”, and “A3” included in the history DB 630, and the processing unit 406 increases the execution count of these combinations from “1” to “2”.

FIGS. 14A-14B show an overview of yet another process (process following FIGS. 12A-12B) executed by the processing unit 406. FIG. 14A shows information on the functional block sequence 120 included in the execution report newly acquired by the processing unit 406 (FIG. 8) of the information processing apparatus 400. In this example, “A1” and “A2” are arranged in order.

The processing unit 406 causes the information on the functional block sequence 120 to be reflected in the history DB 630. FIG. 14B shows a data structure of the history DB 630. The processing unit 406 checks whether each of “A1” and “A2” included in the functional block sequence 120 executed is included in the history DB 630. Since the history DB 630 includes each of “A1” and “A2”, the processing unit 406 increases the execution count of each of “A1” and “A2” in the history DB 630 from “3” to “4”. Further, the processing unit 406 checks whether the combination of “A1” and “A2” included in the functional block sequence 120 executed is included in the history DB 630. Since the history DB 630 includes the combination of “A1” and “A2”, the processing unit 406 increases the execution count of the combination of “A1” and “A2” in the history DB 630 from “3” to “4”.

Since “B1” similar to “A1” and “B2” similar to “A2” are included in the history DB 630, the processing unit 406 increases the execution count of each of “B1” and “B2” in the history DB 630 from “1” to “2”. Similarity determination is as described above so that a description thereof is omitted here. Further, since the combination of “B1” and “B2” similar to the combination of “A1” and “A2” is included in the history DB 630, the processing unit 406 increases the execution count of the combination of “B1” and “B2” in the history DB 630 from “1” to “2”.

FIGS. 15A-15B show an overview of yet another process (process following FIGS. 14A-14B) executed by the processing unit 406. FIG. 15A shows information on the functional block sequence 120 included in the execution report newly acquired by the processing unit 406 (FIG. 8) of the information processing apparatus 400. In this example, “A1” and the functional block 110 “A4” (hereinafter simply referred to as “A4”) are arranged in order.

The processing unit 406 causes the information on the functional block sequence 120 to be reflected in the history DB 630. FIG. 15B shows a data structure of the history DB 630. The processing unit 406 checks whether each of “A1” and “A4” included in the functional block sequence 120 executed is included in the history DB 630. Since the history DB 630 includes “A1”, the processing unit 406 increases the execution count of “A1” in the history DB 630 from “4” to “5”. Since the history DB 630 does not include “A4”, on the other hand, the processing unit 406 assigns an ID “13” to “A4” and records an execution count “1”.

Further, the processing unit 406 checks whether the combination of “A1” and “A4” included in the functional block sequence 120 executed is included in the history DB 630. This combination is not included in the history DB 630. Therefore, the processing unit 406 assigns an ID “14” to the combination of “A1” and “A4” and records an execution count “1”. Further, since “B1” similar to “A1” is included in the history DB 630, the processing unit 406 increases the execution count of “B1” in the history DB 630 from “2” to “3”.

FIGS. 16A-16B show an overview of yet another process (process following FIGS. 15A-15B) executed by the processing unit 406. FIG. 16A shows information on the functional block sequence 120 included in the execution report newly acquired by the processing unit 406 (FIG. 8) of the information processing apparatus 400. In this example, “A1” and “B2” are arranged in order.

The processing unit 406 causes the information on the functional block sequence 120 to be reflected in the history DB 630. FIG. 16B shows a data structure of the history DB 630. The processing unit 406 checks whether each of “A1” and “B2” included in the functional block sequence 120 executed is included in the history DB 630. Since the history DB 630 includes each of “A1” and “B2”, the processing unit 406 increases the execution count of “A1” in the history DB 630 from “5” to “6” and increases the execution count of “B2” in the history DB 630 from “2” to “3”. Further, the processing unit 406 checks whether the combination of “A1” and “B2” included in the functional block sequence 120 executed is included in the history DB 630. This combination is not included in the history DB 630. Therefore, the processing unit 406 assigns an ID “15” to the combination of “A1” and “B2” and records an execution count “1”.

Since “B1” similar to “A1” and “A2” similar to “B2” are included in the history DB 630, the processing unit 406 increases the execution count of “B1” in the history DB 630 from “3” to “4” and increases the execution count of “A2” in the history DB 630 from “4” to “5”. Similarity determination is as described above so that a description thereof is omitted here. Further, since the combination of “A1” and “A2” and the combination of “B1” and “B2” similar to the combination of “A1” and “B2” are included in the history DB 630, the processing unit 406 increases the execution count of the combination of “A1” and “A2” in the history DB 630 from “4” to “5” and increases the execution count of the combination of “B1” and “B2” in the history DB 630 from “2” to “3”.

When the functional block 110 or the combination of the functional blocks 110 in the history DB 630 is executed a certain number of times or more, the registration unit 424 registers the functional block 110 or the combination of the functional blocks 110 as the repeatedly trustable block. Registration is made by, for example, flagging those functional blocks 110 or combinations of the functional blocks 110 in the history DB 630 that qualify as the repeatedly trustable block.

FIG. 17 shows a data structure of the history DB 630. For each ID, information on a single functional block 110 and a combination of a plurality of functional blocks 110 (hereinafter also referred to as a functional block group) is stored. A single block or a functional block group corresponding to an ID including a registration “Y” is the repeatedly trustable block. That is, the registration “Y” corresponds to the aforementioned flag. The single functional block 110 or the functional block group corresponding to an ID including a registration “N” is not registered as the repeatedly trustable block. The registration ID is identification information on the repeatedly trustable block assigned when it is registered as the repeatedly trustable block.

The repeatedly trustable block is the functional block 110 or the functional block group that has been executed many times, i.e., used by many users. It can be said that this is the functional block 110 or the functional block group that realizes an operation suited to the needs of many users and suppresses a decrease in the safety of the appliance 100. By utilizing the repeatedly trustable block, therefore, the creator can generate the functional block sequence 120 that realizes an operation suited to the needs of many users and suppresses a decrease in the safety of the appliance 100.

FIG. 18 shows a data structure of the creator DB 640. For each ID, the first creator of the functional block 110 or the functional block group is indicated. Predecessor information will be described later.

The creator inputs an instruction for requesting the display of the repeatedly trustable block by using the user control unit 204 of the sequence creation apparatus 200 (FIG. 7). The processing unit 206 transmits a signal (hereinafter referred to as a “transmission request signal”) for requesting transmission of the repeatedly trustable block from the communication unit 210 to the information processing apparatus 400.

The communication unit 410 of the information processing apparatus 400 (FIG. 8) receives the transmission request signal from the sequence creation apparatus 200. When the communication unit 410 receives the transmission request signal, the processing unit 406 acquires the repeatedly trustable block from the block DB 610 or the sequence DB 620. The processing unit 406 causes the repeatedly trustable block to be transmitted from the communication unit 410 to the sequence creation apparatus 200 to cause the sequence creation apparatus 200 to display the repeatedly trustable block. A plurality of trust reproduction blocks may be available.

When the communication unit 210 of the sequence creation apparatus 200 receives the repeatedly trustable block from the information processing apparatus 400, the display unit 202 displays the repeatedly trustable block. The creator creates a new functional block sequence 120 by adding a functional block 110 to the repeatedly trustable block displayed on the display unit 202. The sequence creation apparatus 200 transmits the new functional block sequence 120 created to the information processing apparatus 400. The communication unit 410 of the information processing apparatus 400 receives the new functional block sequence 120 from the sequence creation apparatus 200. The processing unit 406 stores the new functional block sequence 120 in the sequence DB 620.

The features are implemented in hardware such as a CPU (Central Processing Unit), a memory, or other LSI's (Large Scale Integration), of any computer and in software such as a program loaded into a memory. The figure depicts functional blocks implemented by the cooperation of these elements. Therefore, it will be understood by those skilled in the art that these functional blocks may be implemented in a variety of manners by hardware only or by a combination of hardware and software.

The operation of the appliance control system 1000 according to the above configuration will be described. FIG. 19 is a sequence chart showing a registration procedure executed by the appliance control system 1000. The appliance 100 executes the functional block sequence 120 (S100). The appliance 100 transmits information on the functional block sequence 120 executed to the information processing apparatus 400 as the execution report (S102). The information processing apparatus 400 acquires the history DB 630 from the storage apparatus 600 (S104). The information processing apparatus 400 updates the history DB 630 based on the information on the functional block sequence 120 executed (S106). The information processing apparatus 400 causes the storage apparatus 600 to store the updated history DB 630 (S108). When the information processing apparatus 400 detects the functional block 110 or the functional block group that has been executed a certain number of times or more (S110), the information processing apparatus 400 registers the functional block 110 or the functional block group as the repeatedly trustable block (S112).

FIG. 20 is a flowchart showing a sequence of steps executed by the information processing apparatus 400. The communication unit 410 receives the execution report (S150). The processing unit 406 extracts the functional block 110 or the functional block group from the functional block sequence 120 executed (S152). When the functional block 110 or the functional block group is in the history DB 630 (Y in S154), the processing unit 406 increases the execution count of the functional block 110 or the functional block group in the history DB 630 (S156). When the functional block 110 or the functional block group is not in the history DB 630 (N in S154), on the other hand, the processing unit 406 registers the functional block 110 or the functional block group in the history DB 630 (S158). In that process, the processing unit 406 assigns a new ID to the functional block 110 or the functional block group. When a similar functional block 110 or a similar

functional block group is in the history DB 630 (Y in S160), the processing unit 406 increases the execution count of the similar functional block 110 or the similar functional block group in the history DB 630 (S162). If there are no similar functional blocks 110 or similar functional block groups in the history DB 630 (N in S160), step 162 is skipped. If there is any unprocessed functional block 110 or unprocessed functional block group (Y in S164), the process returns to step 152. If there are no unprocessed functional blocks 110 or unprocessed functional block groups (N in S164), the process is terminated.

### (4) Modification of Repeatedly Trustable Block

Since the repeatedly trustable block is used by many users, it is a highly reliable functional block 110 or functional block group. If the operating environment or the purpose of operation of the appliance 100 changes, however, the repeatedly trustable block may no longer be optimal in the presence of such a change. At that time, it is desirable to modify the repeatedly trustable block.

The appliance 100 of FIG. 1A is controlled by the user to transmit a transmission request signal to the information processing apparatus 400 to request transmission of the repeatedly trustable block. The communication unit 410 (FIG. 8) of the information processing apparatus 400 receives the transmission request signal from the appliance 100. When the processing unit 406 receives the transmission request signal from the communication unit 410, the processing unit 406 acquires the repeatedly trustable block corresponding to the transmission request signal from the block DB 610 or the sequence DB 620. The processing unit 406 causes the repeatedly trustable block acquired to be transmitted from the communication unit 410 to the appliance 100. FIGS. 21A-21C show an overview of yet another process executed by the processing unit 406. FIG. 21A shows the repeatedly trustable block transmitted from the information processing apparatus 400. By way of one example, “A1” and “A2” are arranged in order in the repeatedly trustable block. FIGS. 21B-21C will be described later.

The communication unit 140 (FIG. 6) of the appliance 100 receives the repeatedly trustable block from the information processing apparatus 400. The processing unit 146 causes the display unit 142 to display the repeatedly trustable block. The user modifies the repeatedly trustable block by changing one or more functional blocks 110 included in the repeatedly trustable block displayed on the display unit 142 by using the user control unit 144. The change to one or more functional blocks 110 included in the repeatedly trustable block includes changing the parameter of the functional block 110, replacing the functional block 110 by another functional block 110, changing the order of the functional blocks 110, and any combination thereof. In this case, it is assumed by way of one example that “A1” is replaced by the functional block 110 “C1” (hereinafter simply referred to as “C1”). As a result, a new functional block sequence 120 in which “C1” and “A2” are arranged in order is generated. Further, the user may add another functional block 110 to the new functional block sequence 120.

The processing unit 146 executes an operation according to the new functional block sequence 120. Thereafter, the communication unit 140 transmits the execution report to the information processing apparatus 400. The execution report includes information on the new functional block sequence 120 executed, information on the source of transmission of that information, and information on the repeatedly trustable block (hereinafter referred to as the “predecessor repeatedly trustable block”) originating the modification. The information on the predecessor repeatedly trustable block may be the ID or the registration ID of FIG. 17.

The communication unit 410 of the information processing apparatus 400 receives the execution report from the appliance 100. FIG. 21B shows information on the new functional block sequence 120 included in the execution report acquired by the processing unit 406 (FIG. 8) of the information processing apparatus 400. In this example, “C1” and “A2” are arranged in order.

The processing unit 406 reflects the information on the functional block sequence 120 in the history DB 630. FIG. 21C shows a data structure of the history DB 630. In FIG. 21C, the execution count up to that point of time is indicated by “*”. The processing unit 406 checks whether each of “C1” and “A2” included in the functional block sequence 120 executed is included in the history DB 630. Since the history DB 630 includes “A2”, the processing unit 406 increases the execution count of “A2” in the history DB 630 by “1”. On the other hand, since the history DB 630 does not include “C1”, the processing unit 406 assigns an ID “16” to “C1” and records an execution count “1”.

Further, the processing unit 406 checks whether the combination of “C1” and “A2” included in the functional block sequence 120 executed is included in the history DB 630. This combination is not included in the history DB 630. Therefore, the processing unit 406 assigns an ID “17” to the combination of “C1” and “A2” and records an execution count “1”. Further, since “B2” similar to “A2” is included in the history DB 630, the processing unit 406 increases the execution count of “B2” in the history DB 630 by “1”.

When an ID is assigned to the functional block 110 or a combination of the functional blocks 110, the processing unit 406 extracts information related to the source of transmission the information and information on the predecessor repeatedly trustable block from the information on the functional block sequence 120 acquired. The processing unit 406 causes the creator DB 640 to store the information on the source of transmission as the creator of the functional block 110 or the combination of the functional blocks 110. Further, the processing unit 406 causes the information on the predecessor repeatedly trustable block to be stored in the predecessor information (FIG. 18) in the creator DB 640.

The same process as above is executed for “C1” and the combination of “C1” and “A2” newly created by modifying the repeatedly trustable block. When the execution count of “C1” is a certain number of times or more, the processing unit 406 registers “C1” as a repeatedly trustable block. Further, when the execution count of the combination of “C1” and “A2” is a certain number of times or more, the processing unit 406 registers the combination of “C1” and “A2” as a repeatedly trustable block.

The operation of the appliance control system 1000 according to the above configuration will be described. FIG. 22 is a sequence chart showing a modification procedure executed by the appliance control system 1000. The appliance 100 searches a menu including a plurality of repeatedly trustable blocks (S200) and selects a repeatedly trustable block. The appliance 100 transmits a transmission request signal to the information processing apparatus 400 (S202), and the information processing apparatus 400 requests the repeatedly trustable block from the storage apparatus 600 (S204). The information processing apparatus 400 acquires the repeatedly trustable block from the storage apparatus 600 (S206) and transmits the repeatedly trustable block to the appliance 100 (S208). In the appliance 100, the repeatedly trustable block is modified (S210). The appliance 100 executes the new functional block sequence 120 and transmits the information on the new functional block sequence 120 executed to the information processing apparatus 400 as the execution report (S212). The information processing apparatus 400 acquires the history DB 630 from the storage apparatus 600 (S214). The information processing apparatus 400 updates the history DB 630 based on the information on the functional block sequence 120 executed (S216). The information processing apparatus 400 causes the storage apparatus 600 to store the history DB 630 updated (S218).

### (5) Calculation of Incentive

Since the repeatedly trustable block is used by many users, the reliability of the repeatedly trustable block is high. Creating various types of repeatedly trustable blocks makes it easy to create the functional block sequence 120 for the appliance 100. As a result, the functional block sequences 120 suited to various applications are created, improving the convenience of the appliance 100. It is desirable that incentives be paid to creators of the repeatedly trustable blocks to encourage creation of different types of repeatedly trustable blocks.

The processing unit 146 of the appliance 100 executes an operation according to the functional block sequence 120. Thereafter, the communication unit 140 of the appliance 100 transmits the execution report to the information processing apparatus 400. The communication unit 410 of the information processing apparatus 400 receives the execution report from the appliance 100. As in the above example, the processing unit 406 causes the information on the functional block sequence 120 included in the execution report to be reflected in the history DB 630. In this process, when the execution count of the repeatedly trustable block increases, the processing unit 406 outputs the ID and the execution count of the repeatedly trustable block for which the count has increased as check parameters to the verification unit 426.

When the verification unit 426 receives the check parameters, the verification unit 426 acquires the first creator corresponding to the ID by accessing the creator DB 640. Further, when predecessor information corresponding to the ID is stored in the creator DB 640, the verification unit 426 also acquires the predecessor information. The predecessor information is an ID assigned to the predecessor repeatedly trustable block when the repeatedly trustable block corresponding to the ID is created by modifying another repeatedly trustable block (hereinafter referred to as the “predecessor repeatedly trustable block”).

The verification unit 426 calculates an incentive for the creator of the repeatedly trustable block according to the execution count. Further, when the predecessor information is acquired, the verification unit 426 calculates an incentive for the creator of the repeatedly trustable block and an incentive for the creator of the predecessor repeatedly trustable block according to the execution count. For calculation of an incentive, a known technology may be used so that a description there of is omitted.

It should be noted here that the repeatedly trustable block for which the execution count is equal to or greater than the count eligible for purchase (>a certain number of times) may be purchased by a company operating the appliance control system 1000. The operating company can incorporate the functional block sequence 120 using the repeatedly trustable block with a proven record or package the sequence and sell the package along with the ingredients. Further, when the repeatedly trustable block involving the appliance 100 of a particular manufacturer is registered, a quality compensation may be paid to the creator from the manufacturer. This is because it is equivalent to testing the sequence by user effort for development and execution without the manufacturer verifying the sequence.

The operation of the appliance control system 1000 according to the above configuration will be described. FIG. 23 is a sequence chart showing an incentive calculation procedure executed by the appliance control system 1000. The appliance 100 executes the functional block sequence 120 (S250). The appliance 100 transmits information on the functional block sequence 120 executed to the information processing apparatus 400 as the execution report (S252). The information processing apparatus 400 acquires the history DB 630 from the storage apparatus 600 (S254). The information processing apparatus 400 updates the history DB 630 based on the information on the functional block sequence 120 executed (S256). The information processing apparatus 400 outputs the check parameters to the verification unit 426 when the execution count of the repeatedly trustable block increases (S258). The verification unit 426 checks the creator of the repeatedly trustable block in the creator DB 640 (S260). The verification unit 426 calculates an incentive for the creator (S262). The verification unit 426 stores the incentive information in the storage apparatus 600 (S164).

### (6) Variation

(6-1)

The processing unit 406 uses the similarity including the first to fourth comparison results to determine whether the functional block 110 included in the functional block sequence 120 executed and the functional block 110 in the history DB 630 are similar. Alternatively, the processing unit 406 may, for example, execute a similarity determination using one of the first to fourth comparison results or two of the first to fourth comparison results.

Further, the processing unit 406 may change the number of comparison results to be used for similarity determination according to the execution count of the functional block 110 in the history DB 630 subject to a comparison. FIG. 24 shows a data structure of a table stored in the storage unit 408. When the execution count is less than the fifth value, the first comparison result is used to determine a similarity. Further, when the execution count is equal to or greater than the fifth value and is smaller than the sixth value, the first and second comparison results are used for similarity determination. It should be noted here that the fifth value<the sixth value. Further, when the execution count is equal to or greater than the sixth value, the first to fourth comparison results are used for similarity determination. The processing unit 406 determines the comparison result to be used for similarity determination by referring to the table of FIG. 24 based on the execution count of the functional block 110 in the history DB 630 subject to comparison.

(6-2)

The processing unit 406 may include the fifth comparison result in the similarity in place of at least one of the first to fourth comparison results or in addition to the first to fourth comparison results. The fifth comparative result is derived as follows. The execution report includes information related to the appliance 100 that has executed the functional block sequence 120 (hereinafter referred to as the “executing appliance”). Further, the history DB 630 also includes information related to the appliance 100 that executed each functional block 110 (hereinafter referred to as the “appliance subject to comparison”). Further, as in the table of FIG. 13 for the functional block 110, categories aggregating similar appliances 100 are predefined.

When the executing appliance and the appliance subject to comparison are the same, the processing unit 406 determines that the fifth comparison result is “2”. Further, when the executing appliance and the appliance subject to comparison are not the same but are included in the same category, the processing unit 406 determines that the fifth comparison result is “1”. Further, when the executing appliance and the appliance subject to comparison are not included in the same category, the processing unit 406 determines that the fifth comparison result is “0”. Such a determination is made for each appliance subject to comparison.

(6-3)

When the functional block 110 includes ingredient state/ingredient type information preceding and succeeding the block, the processing unit 406 may use this information to generate a result of comparison in parameter between the functional block 110 included in the functional block sequence 120 executed and the functional block 110 in the history DB 630. Further, the comparison result may be included in the similarity.

(6-4)

The first value and the second value are defined to determine the second comparison result, and the third value and the fourth value are defined to determine the third comparison result. Depending on the execution count of the functional block 110 in the history DB 630 subject to comparison, at least one of the first to fourth values may be changed. For example, a change may be made so that the first value decreases as the execution count increases, or a change may be made so that the third value decreases as the execution count increases. Such a change makes it more likely that the second comparison result or the third comparison result is determined to be “1” rather than “0” when the execution count is small as compared to when the execution count is large.

(6-5)

The processing unit 406 described so far increases the execution count of the functional block 110 or the functional block group included in the history DB 630 by “1” each time. However, the processing unit 406 may change the increment according to the execution count. For example, when the execution count increases, the increment may be changed from “1” to “0.5”.

(6-6)

In the description so far, the processing unit 406 acquires the information on the functional block sequence 120 included in the execution report and records the execution count of the functional block 110 or the combination of the functional blocks 110 in the information on the functional block sequence 120. For example, the processing unit 406 records the execution count “1” of the functional block 110 “A1” in the state of FIG. 10B and records the execution count “2” of the functional block 110 “A1” in the state of FIG. 11B. Further, the processing unit 406 also records the execution count of the functional block 110 (combination of functional blocks 110) similar to the functional block 110 (combination of functional blocks 110) in the information of the functional block sequence 120. Thus, the processing unit 406 records the execution count “3” of the functional block 110 “A1” in the state of FIG. 12B.

The processing unit 406 may record the execution count of the functional block 110 repeated, that is, the number of times that the block is repeated rather than recording the execution count of the functional block 110 as it is. This is equivalent to recording the execution count of the functional block 110 executed for the second and subsequent times and is equivalent to not including the execution for the first time in the execution count. In this case, the execution count in each of FIGS. 10B, 11B, 12B, 14B, 15B, and 16B is reduced by “1”.

In that process, the processing unit 406 may increase the execution count when the same user executes the functional block 110 for the second or subsequent times, using the identification information on the user included in the execution report. Further, the processing unit 406 may use the information on the executing appliance included in the execution report to increase the execution count when the same appliance 100 executes the functional block 110 for the second or subsequent times. Further, the processing unit 406 may increase the execution count when a block is executed for the second or subsequent times in a range of similarity to the functional block 110.

(6-7)

In the description so far, the registration unit 414 registers the functional block 110 or the combination of the functional blocks 110 as the repeatedly trustable block when the execution count of the functional block 110 or the combination of the functional blocks 110 in the history DB 630 is a certain number of times or more. That is, the execution count is subject to absolute evaluation to register the repeatedly trustable block.

The registration unit 424 may demote the registered repeatedly trustable block to a normal functional block 110 or a normal combination of functional blocks 110. For example, the processing unit 406 also measures the execution count of each registered repeatedly trustable block in a predetermined period and calculates a deviation value of each execution count of a plurality of repeatedly trustable blocks. The registration unit 424 returns the repeatedly trustable block for which the deviation value of the execution count is equal to or less than a predetermined value to a normal functional block 110 or a normal combination of functional blocks 110. That is, the execution count is subject to relative evaluation to demote the repeatedly trustable block. Therefore, even if the repeatedly trustable block “A1” is executed 10,000 times, “A1” will no longer be a repeatedly trustable block if another repeatedly trustable block is executed 100,000 times or more. Further, the registration unit 424 may demote the repeatedly trustable block when the execution count within the immediately preceding predetermined period is equal to or less than a predetermined value.

According to the embodiment, the execution count in the history DB is increased based on the functional block or the functional block group executed, and when the execution count reaches a certain number of times or more, the functional block or the functional block group is registered as a repeatedly trustable block. Therefore, reliable detail of control can be easily registered in the appliance. Further, the execution count in the history DB is increased based on the functional block or the functional block group similar to the functional block or the functional block group executed, and when the execution count reaches a certain number of times or more, the functional block or the functional block group that is similar is registered as a repeatedly trustable block. Therefore, reliable detail of control can be easily registered in the appliance. Further, registration of a repeatedly trustable block is made when the execution count reaches a certain number of times or more so that the safety of the repeatedly trustable block can be ensured. Further, the combination of functional blocks developed by the user is evaluated so that the stability of operating the appliance can also be evaluated. Further, the repeatedly trustable block is used when the user creates a new functional block sequence so that a highly reliable functional block sequence can be created. Further, the functional block sequence created is evaluated so that motivation can be improved.

Further, a similarity between the functional block executed and the functional block in the history DB is derived and a determination is made as to whether they are similar based on the similarity so that a functional block similar to the functional block executed can be found in the history DB. Further, a plurality of types of functional blocks are defined according to the detail of operation so that functional blocks corresponding to various operations can be used. Further, the functional block can receive one or more parameters, it can play the role of an interface with the component. Further, a similarity is derived based on the type of functional block, or the number of parameters included in the functional block, or the value of the parameter included in the functional block, the accuracy of derivation can be improved. Further, the repeatedly trustable block is displayed so that the repeatedly trustable block can be easily used.

Further, when information on a new functional block sequence created by modifying a transmitted repeatedly trustable block and executed in the appliance is received from the appliance, the execution count of the functional block or the functional block group included in the new functional block sequence is also counted so that the functional block or the functional block group can be registered as a new repeatedly trustable bock. Further, the incentive for the creator of the repeatedly trustable block is calculated according to the execution count of the repeatedly trustable block so that the motivation of the creator can be improved. Further, the incentive for the creator of another repeatedly trustable block originating a given repeatedly trustable block is calculated according to the execution count of the given repeatedly trustable block so that the motivation of the creator can be improved. Further, the number of comparison results to be used for similarity determination is changed according to the execution count of the functional block in the history DB so that the ease of similarity determination can be adjusted according to the execution count. Further, as the execution count of the functional block in the history DB increases, the number of comparison results to be used for similar determination is increased so that the smaller the execution count, the easier it is to find a similar functional block.

Further, the repeatedly trustable block is registered based on the number of times of repeated execution so that the current way of living of the user can be reflected. Further, when the execution count of the repeatedly trustable block is small, the repeatedly trustable block is returned to the functional block 110 or a combination of the functional blocks 110 so that the current way of living of the user can be reflected.

A summary of an embodiment of the present disclosure is given below. A registration method according to an embodiment of the present disclosure includes: receiving information on a block sequence executed by an appliance, the block sequence being comprised of an arrangement of blocks defined in a functional unit executable by the appliance in an order of operation; increasing, in a history database showing a history of execution of the block sequence, an execution count of a first block included in the block sequence executed by the appliance; increasing, in the history database, an execution count of a second block similar to the first block; and registering, in the history database, a block for which the execution count is a predetermined number of times or more as a repeatedly trustable block.

The method may further include: deriving a similarity between the first block and the block in the history database; and identifying, based on the similarity, the block in the history database as the second block.

A plurality of types of the blocks may be defined according to a detail of the function, and the block may be adapted to receive one or more parameters, and the similarity may include at least one of (A) a first result of comparison between a type of the first block and a type of the block in the history database, (B) a second result of comparison between the number of parameters included in the first block and the number of parameters included in the block in the history database, (C) a third result of comparison between a value of the parameter included in the first block and a value of the parameter included in the block in the history database, and (D) a fourth result of comparison between a type of the parameter included in the first block and a type of the parameter included in the block in the history database.

The identifying may change the number of results of comparison for identifying the block in the history database as the second block according to the execution count of the block in the history database.

The method may further include displaying the repeatedly trustable block.

The method may further include calculating an incentive for a first creator of the repeatedly trustable block according to the execution count of the repeatedly trustable block.

The method may further include, given that a block created by modifying the repeatedly trustable block is registered as a new repeatedly trustable block, calculating an incentive for a first creator of the new repeatedly trustable block and an incentive for a first creator of the repeatedly trustable block before being modified, according to the execution count of the new repeatedly trustable block.

Another embodiment of the present disclosure relates to an information processing apparatus. The apparatus includes a reception unit that receives information on a block sequence executed by an appliance, the block sequence being comprised of an arrangement of blocks defined in a functional unit executable by the appliance in an order of operation; a processor that increases, in a history database showing a history of execution of the block sequence, an execution count of a first block included in the block sequence executed by the appliance and increases, in the history database, an execution count of a second block similar to the first block; and a registrator that registers, in the history database, a block for which the execution count is a predetermined number of times or more as a repeatedly trustable block.

The present disclosure has been described above based on an exemplary embodiment. The exemplary embodiment intended to be illustrative only and it will be understood by those skilled in the art that various modifications to combinations of constituting elements and processes are possible and that such modifications are also within the scope of the present disclosure.

What is claimed is:

1. A registration method comprising:
receiving information on a block sequence executed by an appliance, the block sequence being comprised of an arrangement of blocks defined in a functional unit executable by the appliance in an order of operation;
increasing, in a history database showing a history of execution of the block sequence, an execution count of a first block included in the block sequence executed by the appliance;
increasing, in the history database, an execution count of a second block similar to the first block; and
registering, in the history database, a block for which the execution count is a predetermined number of times or more as a repeatedly trustable block.

2. The registration method according to claim 1, further comprising:
deriving a similarity between the first block and the block in the history database; and
identifying, based on the similarity, the block in the history database as the second block.

3. The registration method according to claim 2,
wherein a plurality of types of the blocks are defined according to a detail of a function, and the block is adapted to receive one or more parameters,
wherein the similarity includes at least one of (A) a first result of comparison between a type of the first block and a type of the block in the history database, (B) a second result of comparison between the number of parameters included in the first block and the number of parameters included in the block in the history database, (C) a third result of comparison between a value of the parameter included in the first block and a value of the parameter included in the block in the history database, and (D) a fourth result of comparison between a type of the parameter included in the first block and a type of the parameter included in the block in the history database.

4. The registration method according to claim 3,
wherein the identifying changes the number of results of comparison for identifying the block in the history database as the second block according to the execution count of the block in the history database.

5. The registration method according to claim 1, further comprising:
displaying the repeatedly trustable block.

6. The registration method according to claim 2, further comprising:
displaying the repeatedly trustable block.

7. The registration method according to claim 3, further comprising:
displaying the repeatedly trustable block.

8. The registration method according to claim 4, further comprising:
displaying the repeatedly trustable block.

9. The registration method according to claim 1, further comprising:
calculating an incentive for a first creator of the repeatedly trustable block according to the execution count of the repeatedly trustable block.

10. The registration method according to claim 1, further comprising:
given that a block created by modifying the repeatedly trustable block is registered as a new repeatedly trustable block, calculating an incentive for a first creator of the new repeatedly trustable block and an incentive for a first creator of the repeatedly trustable block before being modified, according to the execution count of the new repeatedly trustable block.

11. An information processing apparatus comprising:
a reception unit that receives information on a block sequence executed by an appliance, the block sequence being comprised of an arrangement of blocks defined in a functional unit executable by the appliance in an order of operation;
a processor that increases, in a history database showing a history of execution of the block sequence, an execution count of a first block included in the block sequence executed by the appliance and increases, in the history database, an execution count of a second block similar to the first block; and
a registrator that registers, in the history database, a block for which the execution count is a predetermined number of times or more as a repeatedly trustable block.

12. A program comprising computer-implemented modules including:
a module that receives information on a block sequence executed by an appliance, the block sequence being comprised of an arrangement of blocks defined in a functional unit executable by the appliance in an order of operation;
a module that increases, in a history database showing a history of execution of the block sequence, an execution count of a first block included in the block sequence executed by the appliance;
a module that increases, in the history database, an execution count of a second block similar to the first block;
and a module that registers, in the history database, a block for which the execution count is a predetermined number of times or more as a repeatedly trustable block.
